(19) United States
(12) Patent Application Publication
(10) Pub. No.: US 2002/0080141 A1
(43) Pub. Date: Jun. 27, 2002

(54) Image processing system, device, method, and computer program

(76) Inventors: Masatoshi Imai, Kanagawa (JP); Junichi Fujita, Saitama (JP); Daisuke Hihara, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/912,143

(22) Filed: Jul. 24, 2001

(30) Foreign Application Priority Data
Jul. 24, 2000 (JP) 2000-223162
Jul. 23, 2001 (JP) 2001-221965

(51) Int. Cl. G06F 13/14; G06T 15/40; G06T 15/50; G06T 15/60

(52) U.S. Cl. 345/519; 345/422; 345/426

(57) ABSTRACT

image processing system is capable of expressing a 3-D image correctly even if semitransparent images are complicatedly mixed in the 3-D image. A plurality of image generators each generate image data including a depth distance, from a predetermined reference portion, of an image to be expressed by the image data, and color information thereof. A merger specifies, e.g. sorts, the plurality of received image data in order of the depth distance included in each of the image data and merges the color information of the image data which is for expressing a first image whose depth distance is relatively long and the color information of the image data which is for expressing a second image in an overlapping manner over the first image.

### CROSS-REFERENCE TO RELATED APPLICATIONS

This application is based upon and claims priorities from prior Japanese Patent Application Nos. 2000-223162 filed on Jul. 24, 2000 and 2001-221965 filed on Jul. 23, 2001, the entire contents of both of which are incorporated herein by reference.

### BACKGROUND OF THE INVENTION

The present invention relates to a three-dimensional image processing system and a three-dimensional image processing method for producing a three-dimensional image based on a plurality of image data each including depth information and color information.

In a three-dimensional image processor (hereinafter simply referred to as “image processor”) that produces a three-dimensional image, a frame buffer and a z-buffer, which are widely available in the existing computer systems, are used. Namely, this type of image processor has an interpolation calculator, which receives graphic data generated by geometry processing from an image processing unit and which performs an interpolation calculation based on the received graphic data to generate image data, and a memory including a frame buffer and a z-buffer.

In the frame buffer, image data, which include color information including such as R (Red) values, G (Green) values and B (blue) values of a three-dimensional image to be processed, are drawn. In the z-buffer, z-coordinates each representing a depth distance of a pixel from a specific viewpoint, e.g. the surface of a display that an operator views, are stored. The interpolation calculator receives graphic data, such as a drawing command of a polygon serving as a basic configuration graph of a three-dimensional image, apical coordinates of a polygon in the three-dimensional coordinate system, and color information of each pixel. The interpolation calculator performs an interpolation calculation of depth distances and color information to produce image data indicative of a depth distance and color information on a pixel-by-pixel basis. The depth distances obtained by the interpolation calculation are stored at a predetermined address of the z-buffer and the color information obtained is stored at a predetermined address of the frame buffer, respectively.

In the case where three-dimensional images are overlapped with each other, they are adjusted by a z-buffer algorithm. The z-buffer algorithm refers to hidden surface processing that is performed using the z-buffer, namely, processing for erasing an image at an overlapped portion existing at a position hidden by the other images. The z-buffer algorithm compares adjacent z-coordinates of the plurality of images desired to be drawn with each other on a pixel-by-pixel basis, and judges a back and forth relationship of the images with respect to the display surface. Then, if a depth distance is shorter, namely, an image is placed at a position closer to the viewpoint, the image is drawn, on the other hand, if an image is placed at a position farther from the viewpoint, the image is not drawn. Whereby, an overlapping portion of the image placed at the hidden position is erased.

The following will explain the image processing system that performs complex image processing using a plurality of image processors.

This image processing system has four image processors and a z-comparator. Each image processor draws image data including color information of pixels in the frame buffer, and writes z-coordinates of the pixels that form an image at that time into the z-buffer.

The z-comparator performs hidden surface processing based on image data written into the frame buffer of each image processor and the z-coordinates written into the z-buffer thereof and produces a combined image. More specifically, the z-comparator reads image data and z-coordinates from the respective image processors. Then, image data having the smallest z-coordinate of all the read z-coordinates is used as a three-dimensional image to be processed. In other words, an image using image data closest to the viewpoint is placed at the uppermost side, and image data of an image placed at a lower side of the overlapping portion is subjected to hidden surface erasing, so that a combined image having the overlapping portion is produced.

For example, image data generated by an image processor for drawing a background, image data generated by an image processor for drawing a car, image data generated by an image processor for drawing a building, and image data generated by an image processor for drawing a person are captured, respectively. After that, when an overlapping portion occurs, the image data of the image placed at the back surface of the overlapping portion is subjected to hidden surface erasing by the z-comparator based on z-coordinates.

Accordingly, even in the case of a complicated three-dimensional image, it is possible to perform accurate image processing at high speed by processing image data using a plurality of image processors in a sharing manner, as compared with the case in which such processing is performed only by one image processor.

The foregoing image processing system is introduced as “Image-Composition-Architectures” in the literature “Computer Graphics Principles and Practice.”

In the conventional image processing system mentioned above, the distinction among outputs from the plurality of image processors is made based on magnitudes of z-coordinates, which basically results in simple hidden surface processing. Hence, among a plurality of overlapping three-dimensional images, even if the image whose z-coordinate is relatively small is semitransparent, the hidden surface portion is erased, and this causes a problem in which the semitransparent three-dimensional image cannot be correctly expressed.

It is an object of the present invention is to provide an improved image processing system that is capable of expressing a three-dimensional image correctly even if the three-dimensional image includes semitransparent images in a complex manner.

### SUMMARY OF THE INVENTION

The present invention provides an image processing system, an image processing device, an image processing method, and a computer program.

According to one aspect of the present invention, there is provided an image processing system comprising: a plurality of image generators each for generating image data including a depth distance, from a predetermined reference portion, of an image to be expressed by the image data, and color information of the image; and a merger for receiving the image data from each of the plurality of image generators, wherein the merger specifies the plurality of received image data in order of the depth distance included in each of the image data and merges the color information of the image data which is for expressing a first image whose depth distance is relatively long and the color information of the image data which is for expressing a second image in an overlapping manner over the first image.

It may be arranged that the depth distance is a depth distance of a pixel from the predetermined reference portion and the color information is color information of the pixel, and that the merger specifies the pixels in order of the depth distance of the pixel and merges the color information of the pixels.

It may be arranged that each of the image data includes depth distances of a plurality of pixels and color information of the pixels, and that the merger specifies the pixels having the same two-dimensional coordinates in order of the depth distance of the pixel and merges the color information of the pixels having the same two-dimensional coordinates.

It may be arranged that the merger merges the color information of the image data having the longest depth distance and the color information of the image data having the second longest depth distance, and further merges a result of the merging and the color information of the image data having the third longest depth distance.

It may be arranged that the merger merges the color information of the image data having the longest depth distance and color information of background image data for expressing a background.

It may be arranged that the image data having the longest depth distance is background image data for expressing a background.

It may be arranged that the color information includes luminance values representing three primary colors and a transparency value representing semitransparency.

It may be arranged that the image processing system further comprises a synchronizing unit for synchronizing timings of capturing the image data from the plurality of image generators with image processing timing of the image processing system.

It may be arranged that the plurality of image generators, the merger and the synchronizing unit are partly or wholly comprise a logic circuit and a semiconductor memory, and the logic circuit and the semiconductor memory are mounted on a semiconductor chip.

According to another aspect of the present invention, there is provided an image processing device comprising: a data capturing unit for capturing image data from each of a plurality of image generators each of which generates the image data including a depth distance, from a predetermined reference portion, of an image to be expressed by the image data, and color information of the image; and a color information merger for specifying the plurality of captured image data in order of the depth distance included in each of the image data and merging the color information of the image data which is for expressing a first image whose depth distance is relatively long and the color information of the image data which is for expressing a second image in an overlapping manner over the first image, wherein the data capturing unit and the color information merger are mounted on a semiconductor chip.

It may be arranged that the image processing device further comprises a synchronizing unit for synchronizing timings of capturing the image data from the plurality of image generators with image processing timing of the image processing device.

According to another aspect of the present invention, there is provided an image processing device comprising: a frame buffer for storing image data including color information of an image to be expressed by the image data; a z-buffer for storing a depth distance of the image from a predetermined reference portion; and a communication unit for communicating with a merger, the merger receiving the image data including the color information and the depth distance from each of a plurality of image processing devices including the subject image processing device to specify the plurality of received image data in order of the depth distance included in each of the image data and to merge the color information of the image data which is for expressing a first image whose depth distance is relatively long and the color information of the image data which is for expressing a second image in an overlapping manner over the first image, wherein the frame buffer, the z-buffer and the communication unit are mounted on a semiconductor chip.

According to another aspect of the present invention, there is provided an image processing method to be executed in an image processing system including a plurality of image generators and a merger connected to the plurality of image generators, the method comprising the steps of: causing the plurality of image generators to generate image data each including a depth distance, from a predetermined reference portion, of an image to be expressed by the image data, and color information of the image; and causing the merger to capture the image data from each of the plurality of image generators at predetermined synchronizing timing, to specify the plurality of captured image data in order of the depth distance included in each of the image data and to merge the color information of the image data which is for expressing a first image whose depth distance is relatively long and the color information of the image data which is for expressing a second image in an overlapping manner over the first image.

According to another aspect of the present invention, there is provided a computer program for causing a computer to be operated as an image processing system which system comprises: a plurality of image generators each for generating image data including a depth distance, from a predetermined reference portion, of an image to be expressed by the image data, and color information of the image; and a merger for receiving the image data from each of the plurality of image generators, wherein the merger specifies the plurality of received image data in order of the depth distance included in each of the image data and merges the color information of the image data which is for expressing a first image whose depth distance is relatively long and the color information of the image data which is for expressing a second image in an overlapping manner over the first image.

According to another aspect of the present invention, there is provided an image processing system comprising: a data capturing unit for capturing, over a network, image data from each of a plurality of image generators each of which generates the image data including a depth distance, from a predetermined reference portion, of an image to be expressed by the image data, and color information of the image; and a color information merger for specifying the plurality of captured image data in order of the depth distance included in each of the image data and merging the color information of the image data which is for expressing a first image whose depth distance is relatively long and the color information of the image data which is for expressing a second image in an overlapping manner over the first image.

According to another aspect of the present invention, there is provided an image processing system comprising: a plurality of image generators each for generating image data including a depth distance, from a predetermined reference portion, of an image to be expressed by the image data, and color information of the image; a plurality of mergers for capturing the image data generated by the plurality of image generators and merging the captured image data; and a controller for selecting image generators and at least one merger necessary for processing from the plurality of image generators and the plurality of mergers, wherein the plurality of image generators, the plurality of mergers and the controller are connected to one another over a network, and at least one of the plurality of mergers captures the image data from the selected image generators to specify the plurality of captured image data in order of the depth distance included in each of the image data and to merge the color information of the image data which is for expressing a first image whose depth distance is relatively long and the color information of the image data which is for expressing a second image in an overlapping manner over the first image.

It may be arranged that at least one of the selected image generators has other image generators connected thereto over a network different from the network, and image data is also generated by the other image generators.

It may be arranged that the image data includes data for specifying the target merger which captures the image data.

It may be arranged that the image processing system further comprises a switch for storing data for specifying the image generators and the at least one merger selected by the controller to capture the image data generated by the image generators specified by the stored data and to transmit the captured image data to the at least one merger specified by the stored data.

### BRIEF DESCRIPTION OF THE DRAWINGS

These objects and other objects and advantages of the present invention will become more apparent upon reading of the following detailed description and the accompanying drawings in which:

FIG. 1 is a system configuration view illustrating one embodiment of an image processing system according to the present invention;

FIG. 2 is a configuration view of an image generator;

FIG. 3 is a block diagram illustrating a configuration example of a merger according to the present invention;

FIG. 4 is a diagram explaining generation timing of an external synchronous signal supplied to a device of a prior stage, and that of an internal synchronous signal, wherein (A) shows a configuration view illustrating an image generator and mergers, (B) shows an internal synchronous signal of the merger of a later stage, (C) shows an external synchronous signal outputted from the merger of the later stage, (D) shows an internal synchronous signal of the merger of the prior stage, and (E) shows an external synchronous signal outputted from the merger of the prior stage;

FIG. 5 is a block diagram illustrating a configuration example of the main part of a merging block according to the present invention;

FIG. 6 is a view illustrating the steps of an image processing method using the image processing system according to the present invention;

FIG. 7 is a system configuration view illustrating another embodiment of the image processing system according to the present invention;

FIG. 8 is a system configuration view illustrating another embodiment of the image processing system according to the present invention;

FIG. 9 is a system configuration view illustrating another embodiment of the image processing system according to the present invention;

FIG. 10 is a system configuration view illustrating another embodiment of the image processing system according to the present invention;

FIG. 11 is a configuration view for implementing the image processing system over a network;

FIG. 12 is a view of an example of data transmitted/received between configuration components;

FIG. 13 is a view illustrating the steps to determine configuration components that form the image processing system;

FIG. 14 is another configuration view for implementing the image processing system over a network; and

FIG. 15 is a view of an example of data transmitted/received between configuration components.

### DETAILED DESCRIPTION

The following will explain an embodiment of the present invention wherein the image processing system of the present invention is applied to a system that performs image processing of a three-dimensional model composed of complicated image components such as a game character.

### Entire Structure

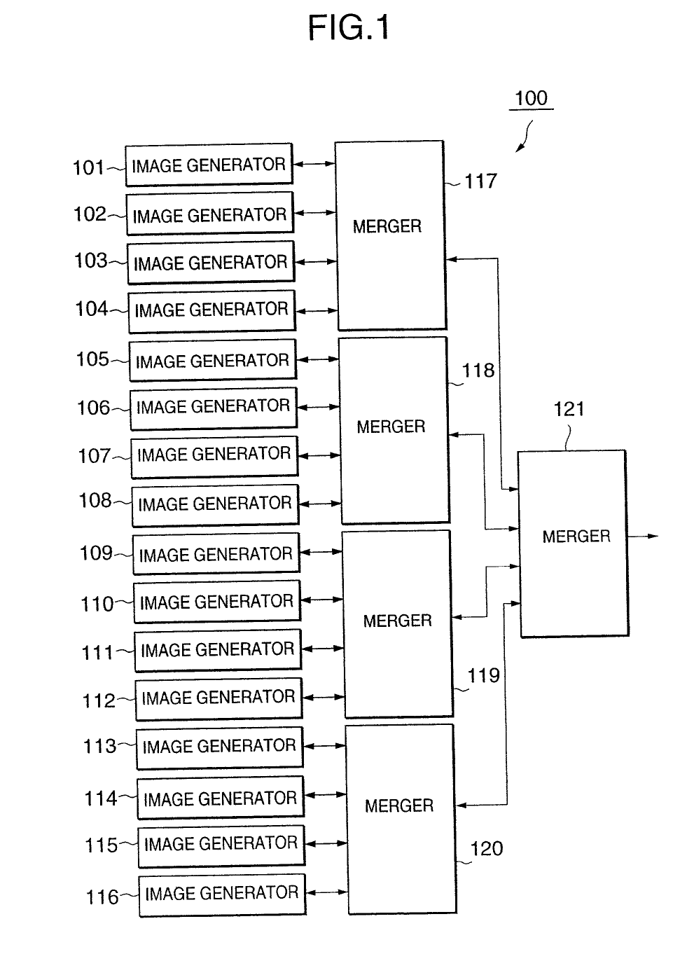

FIG. 1 is an overall structural diagram of the image processing system according to the embodiment of the present invention.

An image processing system 100 comprises sixteen image generators 101 to 116 and five mergers 117 to 121.

Each of image generators 101 to 116 and mergers 117 to 121 has a logic circuit and a semiconductor memory, respectively, and the logic circuit and the semiconductor memory are mounted on one semiconductor chip. The number of image generators and that of mergers can be appropriately determined in accordance with the kind of three-dimensional image to be processed, the number of three-dimensional images, and a processing mode.

Each of the image generators 101 to 116 generates graphic data including three-dimensional coordinates (x, y, z) of each apex of each polygon for forming a stereoscopic 3-D model, homogenous coordinates (s, t) of texture of each polygon and a homogeneous term q by use of geometry processing. The image generator also performs characteristic rendering processing based on the generated graphic data. Moreover, upon receiving external synchronous signals from the mergers 117 to 120 connected to a subsequent stage, the image generators 101 to 116 output color information (R-values, G-values, B-values, A-values), which is the result of rendering processing, from frame buffers to the mergers 117 to 120 of the subsequent stage, respectively. Also, the image generators 101 to 116 output z-coordinates, each indicative of a depth distance of a pixel from a specific viewpoint, e.g. the surface of a display that an operator views, from z-buffers to the mergers 117 to 120 of the subsequent stage, respectively. At this time, the image generators 101 to 116 also output write enable signals WE that allow the mergers 117 to 120 to capture color information (R-values, G-values, B-values, A-values) and z-coordinates concurrently.

The frame buffer and z-buffer are the same as those indicated in the prior art, and R-value, G-value and B-value are luminance values of red, green and blue, respectively, and A-value is a numeric value indicating degree of semitransparency (α).

Each of the mergers 117 to 121 receives output data from the corresponding image generators or the other mergers through a data capturing mechanism, specifically each of the mergers receives image data including (x, y) coordinates indicative of a two-dimensional position of each pixel, color information (R-value, G-value, B-value, A-value) and z-coordinate (z). Then, image data are specified using z-coordinates (z) according to the z-buffer algorithm, and color information (R-values, G-values, B-values, A-values) is blended in order of image data having a longer z-coordinate (z) from the viewpoint. Through this processing, combined image data for expressing a complex three-dimensional image including a semitransparent image, is produced at the merger 121.

Each of the image generators 101 to 116 is connected to any one of the mergers 117 to 120 of the subsequent stage, and the mergers are connected to the merger 121. Hence, it is possible to make multistage connection among the mergers.

In this embodiment, the image generators 101 to 116 are divided into four groups, and one merger is provided for each group. Namely, the image generators 101 to 104 are connected to the merger 117, and the image generators 105 to 108 are connected to the merger 118. The image generators 109 to 112 are connected to the merger 119, and the image generators 113 to 116 are connected to the merger 120. In the respective image generators 113 to 116 and mergers 117 to 121, the synchronization of timing of processing operation can be obtained by synchronous signals to be described later.

In connection with the image generators 101 to 116 and the mergers 117 to 121, the specific configuration and function thereof will be next explained.

### Image Generators

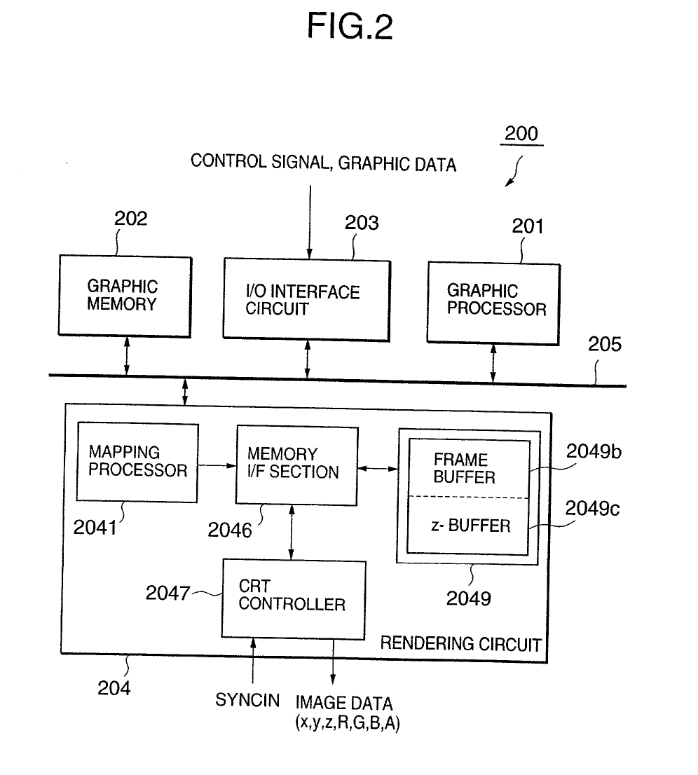

The entire configuration view of the image generator is illustrated in FIG. 2. Since all image generators 101 to 116 have the same configuration components, the respective image generators are uniformly represented by reference numeral 200 in FIG. 2 for the sake of convenience.

An image generator 200 is configured in such a way that a graphic processor 201, graphic memory 202, an I/O interference circuit 203, and a rendering circuit 204 are connected to a bus 205.

The graphic processor 201 reads necessary original data for graphics from the graphic memory 202 that stores original data for graphics in accordance with the progress of an application or the like. Then, the graphic processor 201 performs geometry processing such as coordinate conversion, clipping processing, lighting processing and the like to the read original data for graphics to generate graphic data. After that, the graphic processor 201 supplies this graphic data to the rendering circuit 204 via the bus 205.

The I/O interface circuit 203 has a function of capturing a control signal for controlling the movement of a 3-D model such as a character or the like from an external operating unit (not shown in the figure) or a function of capturing graphic data generated by an external image processing unit. The control signal is sent to the graphic processor 201 so as to be used for controlling the rendering circuit 204.

Graphic data is composed of floating-point values (IEEE format) including, e.g. x-coordinate and y-coordinate having 16 bits, z-coordinate having 24 bits, R-value, G-value, B-value each having 12 bits (=8+4), s, t, q texture coordinates each having 32 bits.

The rendering circuit 204 has a mapping processor 2041, a memory interface (memory I/F) circuit 2046, a CRT controller 2047, and a DRAM (Dynamic Random Access Memory) 2049.

The rendering circuit 204 of this embodiment is formed in such a way that the logic circuit such as the mapping processor 2041 and the like, and the DRAM 2049 for storing image data, texture data and the like are mounted on one semiconductor chip.

The mapping processor 2041 performs linear interpolation to graphic data sent via the bus 205. Linear interpolation makes it possible to obtain color information (R-value, G-value, B-value, A-value) and z-coordinate of each pixel on the surface of a polygon from graphic data, which graphic data represents only color information (R-value, G-value, B-value, A-value) and z-coordinate about each apex of the polygon. Moreover, the mapping processor 2041 calculates texture coordinates using homogeneous coordinates (s, t) and a homogeneous term q, which are included in graphic data, and performs texture mapping using texture data corresponding to the derived texture coordinates. This makes it possible to obtain a more accurate display image.

In this way, pixel data, which is expressed by (x, y, z, R, B, A) including (x, y) coordinates indicative of a two-dimensional position of each pixel, and color information and z-coordinate thereof, is produced.

The memory I/F circuit 2046 gains access (writing/reading) to the DRAM 2049 in response to a request from the other circuit provided in the rendering circuit 204. A writing channel and a reading channel upon accessing are configured separately. Namely, upon writing, a writing address ADRW and writing data DEW are written via the writing channel, and upon reading, reading data DTR is read via the reading channel.

The memory I/F circuit 2046 gains access to the DRAM 2049 in unit of 16 pixels at maximum based on a predetermined interleave addressing in this embodiment.

The CRT controller 2047 makes a request to read image data from the DRAM 2049 via the memory I/F circuit 2046 in synchronization with an external synchronous signal supplied from the merger connected to the subsequent stage, i.e. color information (R-values, G-values, B-values, A-values) of pixels from a frame buffer 2049b and z-coordinates of the pixels from a z-buffer 2049c. Then, the CRT controller 2047 outputs image data, including the read color information (R-values, G-values, B-values, A-values) and z-coordinates of the pixels and further including (x, y) coordinates of the pixels, and a write enable signal WE as a writing signal to the merger of the subsequent stage.

The number of pixels of which color information and z-coordinates are read from the DRAM 2049 per one access and outputted to the merger with one write enable signal WE is 16 at maximum in this embodiment and changes depending on e.g. a requirement from an application being executed. Although the number of pixels for each access and output can take any possible value including 1, it is assumed in the following description that the number of pixels for each access and output is 16 for brevity of description. Moreover, (x, y) coordinates of pixels for each access is determined by a main controller (not shown) and notified to the CRT controller 2047 of each of the image generators 101 to 116 in response to an external synchronous signal sent from the merger 121. Thus, (x, y) coordinates of pixels for each access are the same among the image generators 101 to 116.

The DRAM 2049 further stores texture data in the frame buffer 2049b.

### Mergers

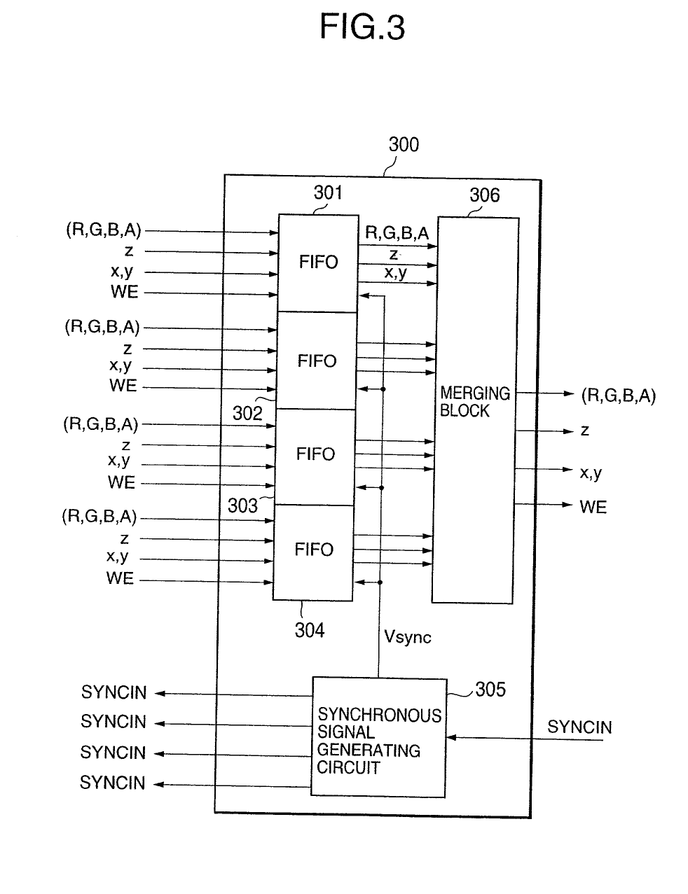

The entire configuration view of the merger is illustrated in FIG. 3. Since all mergers 117 to 121 have the same configuration components, the respective mergers are uniformly represented by reference numeral 300 in FIG. 3 for the sake of convenience.

A merger 300 is composed of FIFOs 301 to 304, a synchronous signal generating circuit 305 and a merging block 306.

FIFOs 301 to 304 are in a one-to-one correspondence with four image generators provided in the prior stage, and each temporarily stores image data, i.e. color information (R-values, G-values, B-values, A-values), (x, y) coordinates and z-coordinates of 16 pixels, outputted from the corresponding image generator. In each of FIFOs 301 to 304, such image data is written in synchronization with the write enable signal WE from the corresponding image generator. The written image data in FIFOs 301 to 304 are outputted to the merging block 306 in synchronization with an internal synchronous signal V sync generated by the synchronous signal generating circuit 305. Since the image data are outputted from the FIFOs 301 to 304 in synchronization with the internal synchronous signals V sync, the input timing of the image data to the merger 300 can be freely set to a certain degree. Accordingly, the complete synchronous operation among the image generators is not necessarily required. In the merger 300, the outputs of the respective FIFOs 301 to 304 are substantially completely synchronized by the internal synchronous signals Vsync. Thus, the outputs of the respective FIFOs 301 to 304 can be sorted at the merging block 306 and blending (α blending) of color information is performed in order of the position farther from the viewpoint. This makes it easy to merge four image data outputted from the FIFOs 301 to 304, which will be described later in detail.

Though the above has explained the example using four FIFOs, this is because the number of image generators to be connected to one merger is four. The number of FIFOs may be set to correspond to the number of image generators to be connected without being limited to four. Moreover, physically different memories may be used as FIFOs 301 to 304. Still moreover, one memory may be logically divided into a plurality of regions.

From the synchronous signal generating circuit 305, an external synchronous signal SYNCIN inputted from a later-stage device of the merger 300, e.g. a display, is supplied to the image generators or the mergers of the prior stage at the same timing.

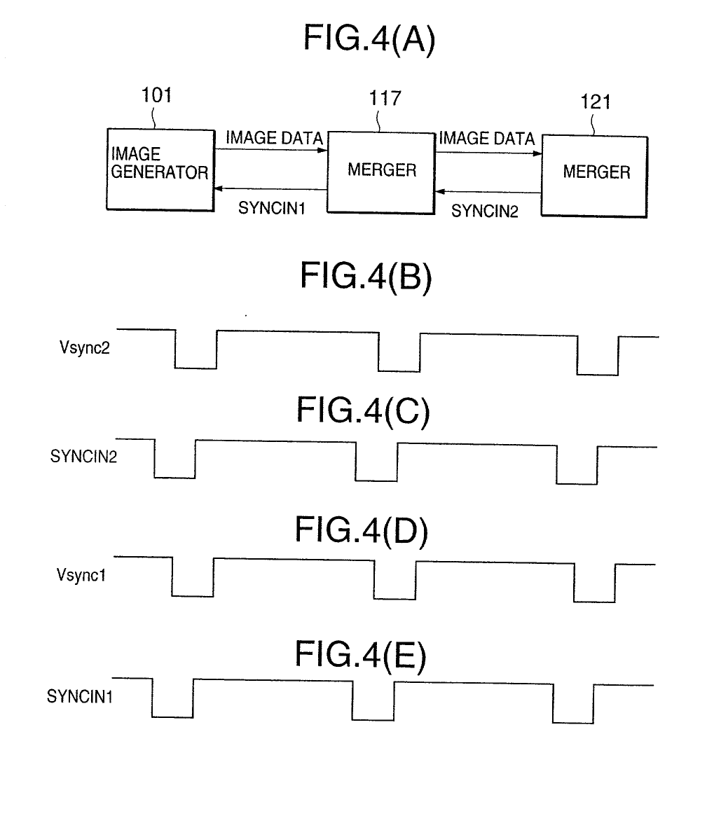

An explanation will be next given of the generation timing of the external synchronous signal SYNCIN supplied from the merger to the prior-stage apparatus and that of the internal synchronous signal Vsync of the merger with reference to FIG. 4.

The synchronous signal generating circuit 305 generates the external synchronous signal SYNCIN and the internal synchronous signal Vsync. Herein, as illustrated at (A) in FIG. 4, an example in which the merger 121, merger 117, and image generator 101 are connected to one another in a three-stage manner is explained.

It is assumed that an internal synchronous signal of the merger 121 is represented by Vsync2 and an external synchronous signal thereof is represented by SYNCIN2. Also, it is assumed that an internal synchronous signal of the merger 117 is represented by Vsync1 and an external synchronous signal thereof is represented by SYNCIN1.

As illustrated at (B) to (E) in FIG. 4, the generation timing of external synchronous signals SYNCIN2 and SYNCIN1 is accelerated by a predetermined period as compared with that of internal synchronous signals Vsync2 and Vsync1 of the mergers. For achieving the multi-stage connection, the internal synchronous signal of the merger follows the external synchronous signal supplied from the merger of the subsequent stage. The acceleration period is intended to allow for a period that elapses before the actual synchronous operation is started after the image generator receives the external synchronous signal SYNCIN. FIFOs 301 to 304 are arranged with respect to the input of the mergers. Hence, no problem arises even if a slight variation in time occurs.

The acceleration period is set in such a way that writing of image data into FIFOs is ended before reading of the image data from FIFOs. This acceleration period can be easily implemented by a sequence circuit such as a counter since the synchronous signals are repeated at a fixed cycle.

Also, the sequence circuit such as a counter may be reset by a synchronous signal from the later stage, making it possible for an internal synchronous signal to follow an external synchronous signal supplied from the merger of the later stage.

The merging block 306 sorts four image data supplied from FIFOs 301 to 304 in synchronization with the internal synchronous signal Vsync by use of z-coordinates (z) included in the four image data, performs blending of color information (R-values, G-values, B-values, A-values), namely a blending, by use of A-values in order of the position farther from the viewpoint, and outputs the resultant to the merger 121 of the subsequent stage at predetermined timing.

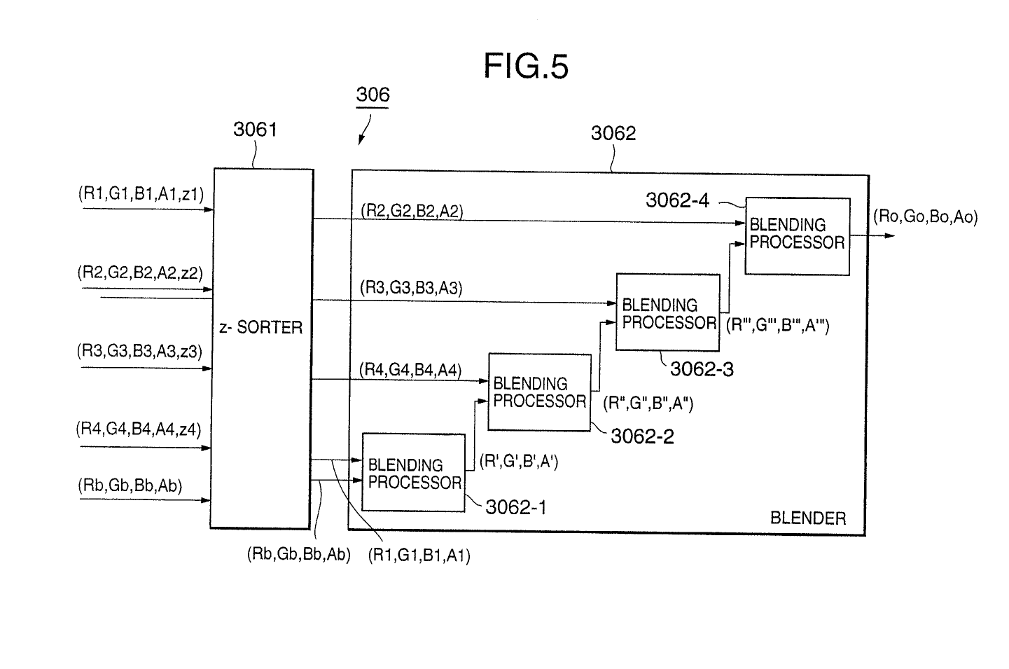

FIG. 5 is a block diagram illustrating the main configuration of the merging block 306. The merging block 306 has a z-sorter 3061 and a blender 3062.

The z-sorter 3061 receives color information (R-values, G-values, B-values, A-values), (x, y) coordinates and z-coordinates of 16 pixels from each of FIFOs 301 to 304. Then, the z-sorter 3061 selects four pixels having the same (x, y) coordinates and compares z-coordinates of the selected pixels in terms of magnitude of values. Selection order of (x, y) coordinates among 16 pixels is predetermined in this embodiment. As shown in FIG. 5, it is assumed that color information and z-coordinates of pixels from FIFOs 301 to 304 are represented by (R1, G1, B1, A1) to (R4, G4, B4, A4) and z1 to z4, respectively. After comparison among z1 to z4, the z-sorter 3061 sorts the 4 pixels in order of decreasing the z-coordinates (z), namely in order of a position of a pixel farther from the viewpoint based on the comparison result, and supplies color information to the blender 3062 in order of the position of the pixel farther from the viewpoint. In the example of FIG. 5, it is assumed that a relationship of z1>z4>z3>z2 is established.

The blender 3062 has four blending processors 3062-1 to 3062-4. The number of blending processors may be appropriately determined by the number of color information to be merged.

The blending processor 3062-1 performs calculations as in e.g. equations (1) to (3) to perform α blend processing. In this case, the calculations are performed using color information (R1, G1, B1, A1) of the pixel located at the position farthest from the viewpoint resulting from the sorting and color information (Rb, Gb, Bb, Ab), which is stored in a register (not shown) and which relates to a background of an image generated by the display. As appreciated, the pixel having color information (Rb, Gb, Bb, Ab) relating to the background is located farthest from the viewpoint. Then, the blending processor 3062-1 supplies resultant color information (R′ value, G′ value, B′ value, A′ value) to the blending processor 3062-2.

R′=R1×A1+(1−A1)×Rb (1)

G′=G1×A1+(1−A1)×Gb (2)

B′=B1×A1+(1−A1)×Bb (3)

A′ value is derived by the sum of Ab and A1.

The blending processor 3062-2 performs calculations as in e.g. equations (4) to (6) to perform α blend processing. In this case, the calculations are performed using color information (R4, G4, B4, A4) of the pixel located at the position, which is the second farthest from the viewpoint resulting from the sorting, and the calculation result (R′, G′, B′, A′) of the blending processor 3062 -1. Then, the blending processor 3062-2 supplies resultant color information (R″ value, G″ value, B″ value, A″ value) to the blending processor 3062-3.

R″=R4×A4+(1−A4)×R′ (4)

G″=G4×A4+(1−A4)×G′ (5)

B″=B4×A1+(1−A4)×B′ (6)

A″ value is derived by the sum of A′ and A4.

The blending processor 3062-3 performs calculations as in e.g. equations (7) to (9) to perform a blend processing. In this case, the calculations are performed using color information (R3, G3, B3, A3) of the pixel located at the position, which is the third farthest from the viewpoint resulting from the sorting, and the calculation result (R″, G″, B″, A″) of the blending processor 3062-2. Then, the blending processor 3062-3 supplies resultant color information (R′″ value, G′″ value, B′″ value, A′″ value) to the blending processor 3062-4.

R′″=R3×A3+(1−A3)×R″ (7)

G′″=G3×A3+(1−A3)×G″ (8)

B′″=B3×A3+(1−A3)×B″ (9)

A′″ value is derived by the sum of A″ and A3.

The blending processor 3062-4 performs calculations as in e.g. equations (10) to (12) to perform α blend processing. In this case, the calculations are performed using color information (R2, G2, B2, A2) of the pixel located at the position, which is the closest to the viewpoint resulting from the sorting, and the calculation result (R′″, G′″, B′″, A′″) of the blending processor 3062-3. Then, the blending processor 3062-4 derives final color information (Ro value, Go value, Bo value, Ao value).

Ro=R2×A2+(1−A2)×R′″ (10)

Go=G2×A2+(1−A2)×G′″ (11)

Bo=B2×A2+(1−A2)×B′″ (12)

Ao value is derived by the sum of A′″ and A2.

The z-sorter 3061 then selects next four pixels having the same (x, y) coordinates and compares z-coordinates of the selected pixels in terms of magnitude of values. Then, the z-sorter 3061 sorts the 4 pixels in order of decreasing the z-coordinates (z) as in the foregoing manner and supplies color information to the blender 3062 in order of the position of the pixel farther from the viewpoint. Subsequently, the blender 3062 performs the foregoing processing as represented by the equations (1) to (12) and derives final color information (Ro value, Go value, Bo value, Ao value). In this fashion, final color information (Ro values, Go values, Bo values, Ao values) of 16 pixels is derived.

The final color information (Ro values, Go values, Bo values, Ao values) of 16 pixels is then sent to a merger of a subsequent stage. In the case of the merger 121 of the final stage, an image is displayed on the display based on the obtained final color information (Ro values, Go values, Bo values).

### Operation Mode

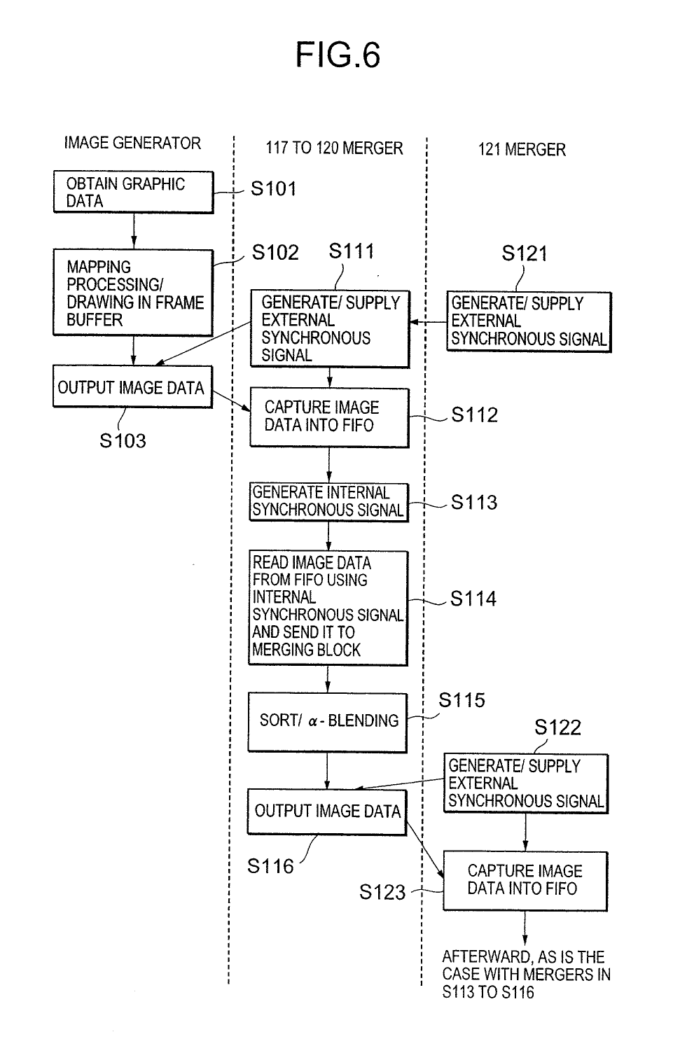

An explanation will be next given of the operation mode of the image processing system with particular emphasis on the procedures of the image processing method by use of FIG. 6.

When graphic data is supplied to the rendering circuit 204 of the image generator via the bus 205, this graphic data is supplied to the mapping processor 2041 of the rendering circuit 204 (step Si 01). The mapping processor 2041 performs linear interpolation, texture mapping and the like based on the graphic data. The mapping processor 2041 first calculates a variation which is generated when a polygon moves by a unit length, based on coordinates of two apexes of the polygon and a distance between the two apexes. Sequentially, the mapping processor 2041 calculates interpolation data for each pixel in the polygon from the calculated variation. The interpolation data includes coordinates (x, y, z, s, t, q), R-value, G-value, B-value, and A-value. Next, the mapping processor 2041 calculates texture coordinates (u, v) based on the coordinate values (s, t, q) included in the interpolation data. The mapping processor 2041 reads each color information (R-value, G-value, B-value) of texture data from the DRAM 2049 based on the texture coordinates (u, v). After that, the color information (R-value, G-value, B-value) of the read texture data, and the color information (R-value, G-value, B-value) included in the interpolation data are multiplied to generate pixel data. The generated pixel data is sent to the memory I/F circuit 2046 from the mapping processor 2041.

The memory I/F circuit 2046 compares z-coordinate of the pixel data inputted from the mapping processor 2041 with z-coordinate stored in the z-buffer 2049c, and determines whether or not an image drawn by the pixel data is positioned closer to the viewpoint than an image written in the frame buffer 2049b is. In the case where the image drawn by the pixel data is positioned closer to the viewpoint than the image written in the frame buffer 2049b is, the buffer 2049c is updated with respect to the z-coordinate of pixel data. In this case, color information (R-value, G-value, B-value, A-value) of pixel data is drawn in the frame buffer 2049b (step S102).

Moreover, the adjacent portions of pixel data in the display area are arranged to obtain different DRAM modules under control of the memory I/F circuit 2046.

In each of the mergers 117 to 120, the synchronous signal generating circuit 305 receives an external synchronous signal SYNCIN from the merger 121 of the subsequent stage, and supplies an external synchronous signal SYNCIN to each of the corresponding image generators (steps S111, S121).

In each of the image generators 101 to 116, which have received the external synchronous signals SYNCIN from the mergers 117 to 120, a request for reading color information (R-values, G-values, B-values, A-values) drawn in the frame buffer 2049b and for reading z-coordinates stored in the z-buffer frame 2049b is sent to the memory I/F circuit 2046 from the CRT controller 2047 in synchronization with the external synchronous signal SYNCIN. Then, image data including the read color information (R-values, G-values, B-values, A-values) and z-coordinates, and a write enable signal WE as a writing signal are sent to corresponding one of the mergers 117 to 120 from the CRT controller 2047 (step S103).

The image data and the write enable signals WE are sent to the merger 117 from the image generators 101 to 104, to the merger 118 from the image generators 105 to 108, to the merger 119 from the image generators 109 to 112, and to the merger 120 from the image generators 113 to 116.

In each of the mergers 117 to 120, image data are written into FIFOs 301 to 304 respectively in synchronization with the write enable signals WE from the corresponding image generators (step S112). Then, the image data written into FIFOs 301 to 304 are read in synchronization with the internal synchronous signal Vsync generated with a delay of a predetermined period from the external synchronous signal SYNCIN. Then, the read image data are sent to the merging block 306 (steps S113, S114).

The merging block 306 of each of the mergers 117 to 120 receives the image data sent from FIFOs 301 to 304 in synchronization with the internal synchronous signal Vsync, performs comparison among the z-coordinates included in the image data in terms of magnitude of the values, and sorts the image data based on the comparison result. As a result of the sorting, the merging block 306 performs cc blending of color information (R-values, G-values, B-values, A-values) in order of the position farther from the viewpoint (step S115). Image data including new color information (R-values, G-values, B-values, A-values) obtained by blending is outputted to the merger 121 in synchronization with an external synchronous signal sent from the merger 121 (steps S116, 122).

In the merger 121, image data is received from the mergers 117 to 120, and the same processing as those of mergers 117 to 120 is performed (step S123). The color of the final image and the like are determined based on the image data resulting from the processing carried out by the merger 121. Through repetition of the foregoing processing, moving images are produced.

In the foregoing manner, the image having been subjected to transparent processing by α blending is produced.

The merging block 306 has the z-sorter 3061 and the blender 3062. This makes it possible to perform transparency processing that is carried out by the blender 3062 by use of α blending in addition to the conventional hidden surface processing that is carried out by the z-sorter 3061 according to the z-buffer algorithm. Such processing is performed for all pixels, making it easy to generate a combined image in which images generated by the plurality of image generators are merged. This makes it possible to correctly process complicated graphics in which semitransparent graphics are mixed. Accordingly, the complicated semitransparent object is allowed to be displayed with high definition, and this can be used in the field such as a game using the 3-D computer graphics, VR (Virtual Reality), design, and the like.

### Other Embodiments

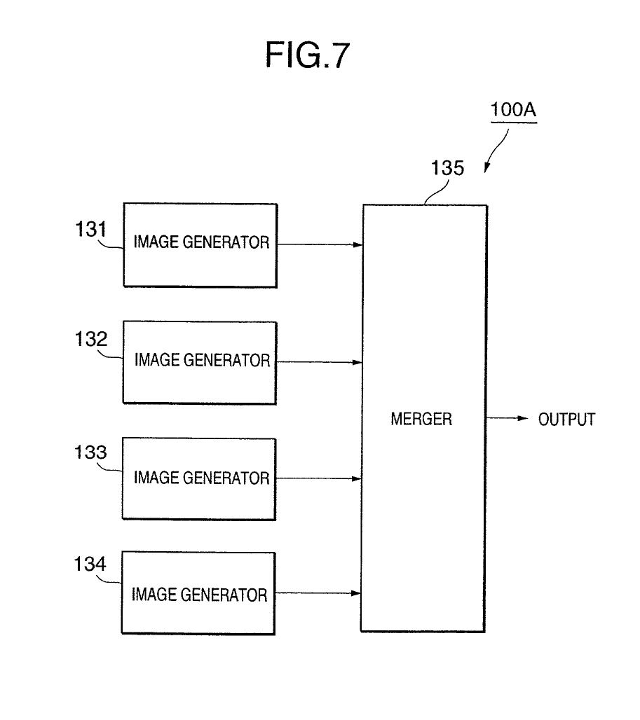

The present invention is not limited to the aforementioned embodiment. In the image processing system illustrated in FIG. 1, four image generators are connected to each of four mergers 117 to 120, and the four mergers 117 to 120 are connected to the merger 121. In addition to this embodiment, embodiments as illustrated in e.g. FIGS. 7 to 10 may be possible.

FIG. 7 illustrates an embodiment in which a plurality of image generators (four in this case) are connected to one merger 135 in parallel to obtain a final output.

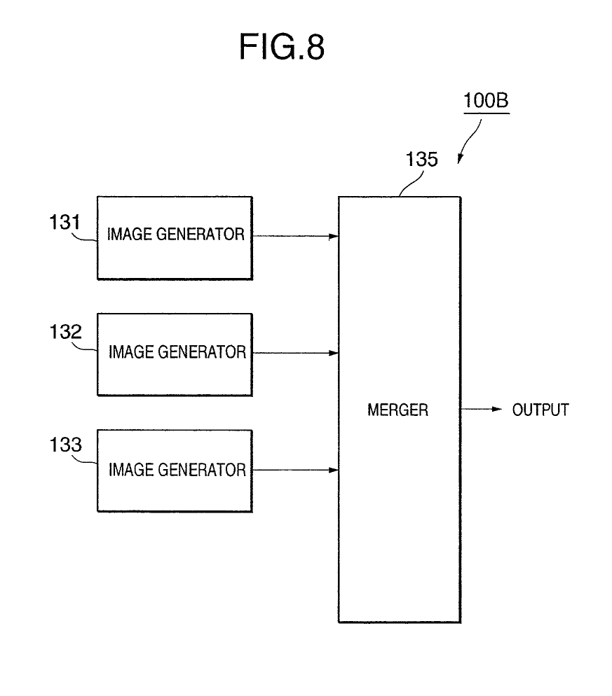

FIG. 8 illustrates an embodiment in which three image generators are connected to one merger 135 in parallel to obtain a final output even though four image generators are connectable to the merger 135.

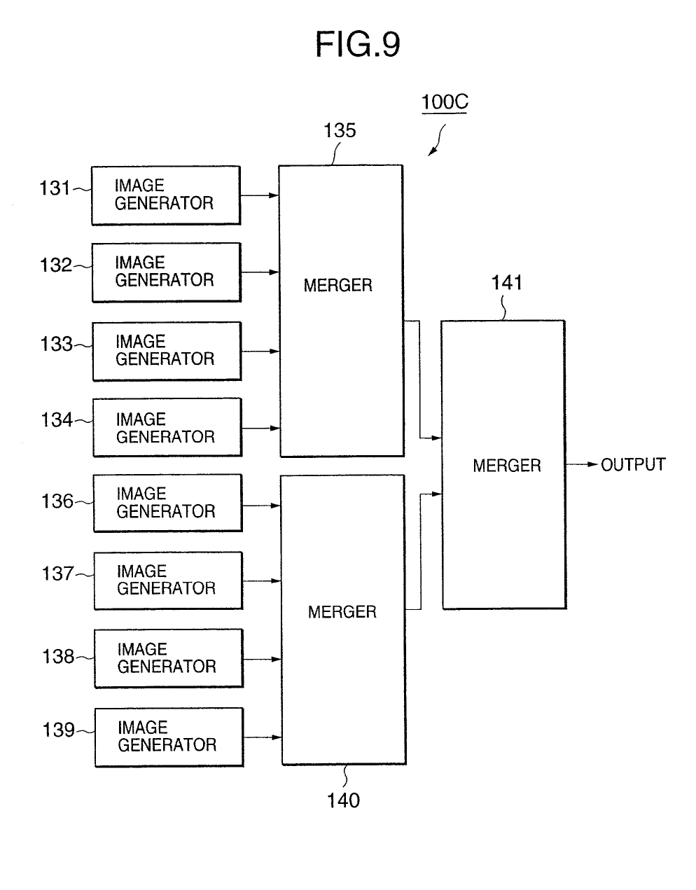

FIG. 9 illustrates an embodiment of the so-called symmetrical system in which four image generators 131 to 134, and 136 to 139 are connected to mergers 135 and 140 to which four image generators are connectable, respectively. Moreover, the outputs of the mergers 135 and 140 are inputted to a merger 141.

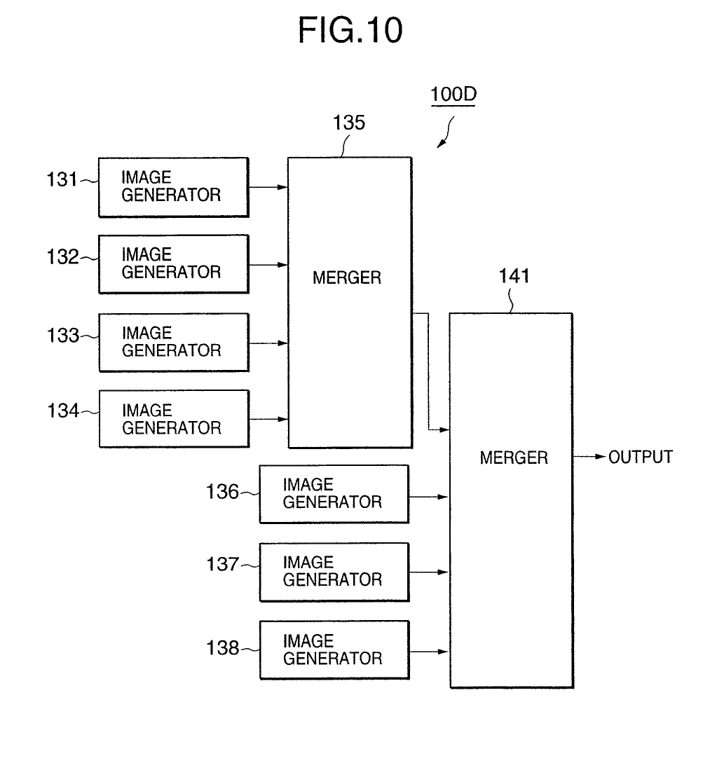

FIG. 10 illustrates an embodiment as follows. Specifically, when connecting mergers in a multi-stage manner, instead of the completely symmetry as illustrated in FIG. 9, four image generators 131 to 134 are connected to a merger 135 to which four image generators are connectable, and the output of the merger 135 and three image generators 136 to 138 are connected to a merger 141 to which four image generators are connectable.

### Embodiment in Case of using Network

The image processing system of each of the aforementioned embodiments is composed of the image generators and the mergers provided close to one another, and such an image processing system is implemented by connecting the respective devices using the short transmission lines. Such an image processing system is containable in one housing.

In addition to the case in which the image generators and the mergers are thus provided close to one another, there can be considered the case in which the image generators and the mergers are provided at completely different positions. Even in such a case, they are connected to one another over the network to transmit/receive data mutually, whereby making it possible to implement the image processing system of the present invention. The following will explain an embodiment using the network.

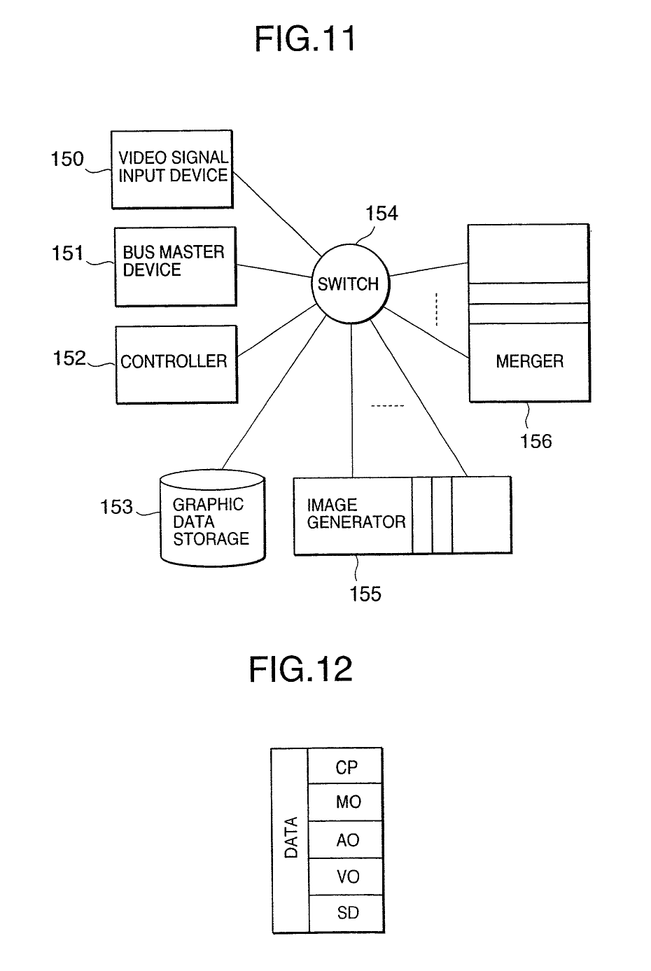

FIG. 11 is a view illustrating a configuration example for implementing the image processing system over the network. In order to implement the image processing system, a plurality of image generators 155 and mergers 156 are connected to an exchange or switch 154 over the network, respectively.

The image generator 155 has the same configuration and function as those of the image generator 200 illustrated in FIG. 2.

The merger 156 has the same configuration and function as those of the merger 300 illustrated in FIG. 3. Image data generated by the plurality of image generators 155 are sent to the corresponding mergers 156 via the switch 154 and are merged therein so that combined images are produced.

In addition to the above, the image processing system of this embodiment comprises a video signal input device 150, a bus master device 151, a controller 152, and a graphic data storage 153. The video signal input device 150 receives inputs of image data from the exterior, the bus master device 151 initializes the network and manages the respective configuration components on the network, the controller 152 determines a connection mode among the configuration components, and the graphic data storage 153 stores graphic data. These configuration components are also connected to the switch 154 over the network.

The bus master device 151 obtains information relating to addresses and performance, and the contents of processing in connection with all configuration components connected to the switch 154 at the time of starting processing. The bus master device 151 also produces an address map including the obtained information. The produced address map is sent to all configuration components.

The controller 152 carries out the selection and determination of the configuration components to be used in performing image processing, namely the configuration components that form the image processing system over the network. Since the address map includes information about the performance of the configuration components, it is possible to select the configuration component in accordance with the load of processing and the contents in connection with the processing to be executed.

Information, indicative of the configuration of the image processing system, is sent to all configuration components that form the image processing system so as to be stored in such all configuration components including the switch 154. This makes it possible for each configuration component to know which configuration component can perform data transmission and reception. The controller 152 can establish a link with another network.

The graphic data storage 153 is a storage with a large capacity such as a hard disk, and stores graphic data to be processed by the image generators 155. The graphic data is inputted from e.g. the exterior via the video signal input device 150.

The switch 154 controls the transmission channels of data to ensure correct data transmission and reception among the respective configuration components.

Data transmitted and received among the respective configuration components via the switch 154 includes data indicative of configuration components, such as addresses, of the receiving side, and is preferably in the form of e.g. packet data.

The switch 154 sends data to a configuration component identified by the address. The address uniquely indicates the configuration component (bus master device 151, etc.) on the network. In the case where the network is the Internet, an IP (Internet Protocol) address can be used.

An example of such data is shown in FIG. 12. Each data includes an address of a configuration component on the receiving side.

Data “CP” represents a program to be executed by the controller 152.

“M0” represents data to be processed by the merger 156. If a plurality of mergers are provided, each merger may be allocated a number so that a target merger can be identified. Accordingly, “M0” represents data to be processed by a merger allocated a number “0”. Similarly, “M1” represents data to be processed by a merger allocated a number “1”, and “M2” represents data to be processed by a merger allocated a number “2”.

Data “A0” represents data to be processed by the image generator 155. Similarly to the mergers, if a plurality of image generators are provided, each image generator may be allocated a number so that a target image generator can be identified.

Data “V0” represents data to be processed by the video signal input device 150. Data “SD” represents data to be stored in the graphic data storage 153.

The foregoing data is sent alone or in combination to configuration components on the receiving side.

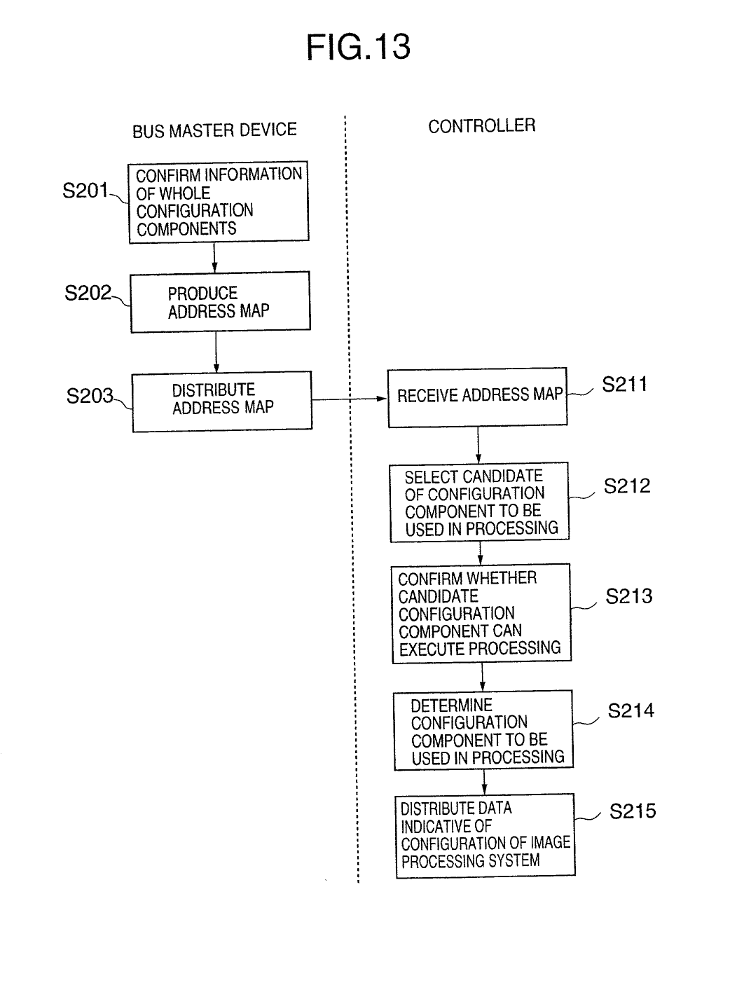

An explanation will be given of the steps to determine configuration components that form the image processing system with reference to FIG. 13.

First, the bus master device 151 sends data for confirming information such as the processing contents, processing performance and addresses, to all configuration components connected to the switch 154. The respective configuration components send data, which includes information of the processing contents, processing performance and address, to the bus master device 151 in response to the data from sent the bus master device 151 (step S201).

When the bus master device 151 receives data sent from the respective configuration components, the bus master device 151 produces an address map about the processing contents, processing performance and address (step S202). The produced address map is offered to all configuration components (step S203).

The controller 152 determines candidates of the configuration components that execute the image processing, based on the address map (steps S211, S212). The controller 152 transmits confirmation data to the candidate configuration components in order to confirm whether the candidate configuration components can execute the processing to be requested (step S213). Each of the candidate configuration components that have received the confirmation data from the controller 152 sends data, which indicates that the execution is possible or impossible, to the controller 152. The controller 152 analyzes the contents of data indicating that the execution is possible or impossible, and finally determines the configuration components to request the processing from among the configuration components from which data indicating that the execution is possible have been received, based on the analytical result (step S214). Then, by combination of the determined configuration components, the configuration contents of the image processing system over the network is finalized. Data, which indicates the finalized configuration contents of the image processing system, is called “configuration contents data.” This configuration contents data is offered to all configuration components that form the image processing system (step S215).

The configuration components to be used in the image processing are determined through the aforementioned steps, and the configuration of the image processing system is determined based on the finalized configuration contents data. For example, in the case where sixteen image generators 155 and five mergers 156 are used, the same image processing system as that of FIG. 1 can be configured. In the case where seven image generators 155 and two mergers 156 are used, the same image processing system as that of FIG. 10 can be configured.

In this way, it is possible to freely determine the configuration contents of the image processing system using various configuration components on the network in accordance with the purpose.

An explanation will be next given of the steps of the image processing using the image processing system of this embodiment. These processing steps are substantially the same as those of FIG. 6.

Each of the image generators 155 performs rendering to graphic data supplied from the graphic data storage 153 or graphic data generated by the graphic processor 201 provided in the image generator 155, by use of the rendering circuit 204, and generates image data (steps S101, S102).

Among the mergers 156, the merger 156, which performs the final image combination, generates an external synchronous signal SYNCIN and sends this external synchronous signal SYNCIN to the mergers 156 or the image generators 155 of a prior stage. In the case where other mergers 156 are further provided in a prior stage, each merger 156, which has received the external synchronous signal SYNCIN, sends an external synchronous signal SYNCIN to corresponding ones of such other mergers 156. In the case where the image generators 155 are provided in the prior stage, each merger 156 sends an external synchronous signal SYNCIN to corresponding ones of the image generators 155 (steps S111, S121).

Each image generator 155 sends the generated image data to the corresponding merger 156 of a subsequent stage in synchronization with the inputted external synchronous signal SYNCIN. In the image data, an address of the merger 156 as a destination is added at the head portion (step S103).

Each merger 156 to which the image data has been inputted merges the inputted image data (steps S112 to S115) to produce combined image data. Each merger 156 sends the combined image data to the merger 156 of a subsequent stage in synchronization with an external synchronous signal SYNCIN inputted at next timing (steps S122, S116). Then, the combined image data finally obtained by the merger 156 is used as an output of the entire image processing system.

The merger 156 has difficulty in receiving image data synchronously from the plurality of image generators 155. However, as illustrated in FIG. 3, the image data are once captured in FIFOs 301 to 304 and are then supplied to the merging block 306 therefrom in synchronization with the internal synchronous signal Vsync. Whereby, synchronization of image data is completely established at the time of image merging. This makes it easy to synchronize image data upon image merging even in the image processing system of this embodiment established over the network.

The use of the fact that the controller 152 can establish a link with another network makes it possible to implement the integrated image processing system using another image processing system formed in the other network as configuration components partially or wholly.

In other words, this can be executed as an image processing system with “a nested structure.”

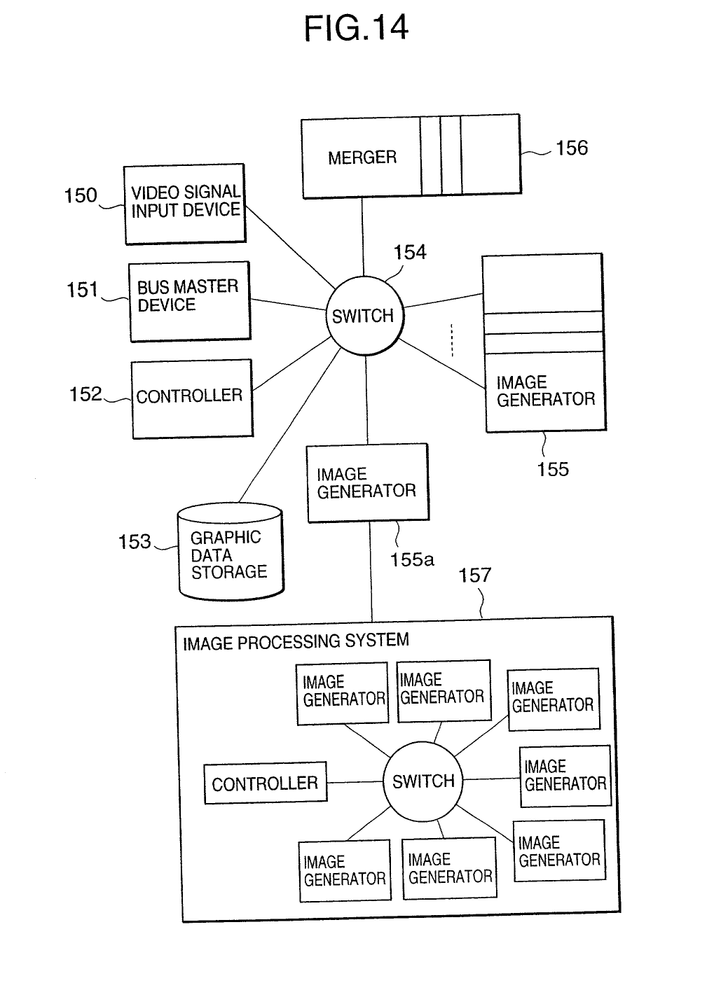

FIG. 14 is a view illustrating a configuration example of the integrated image processing system, and a portion shown by reference numeral 157 indicates an image processing system having a controller and a plurality of image generators. Although not shown in FIG. 14, the image processing system 157 may further include a video signal input device, a bus master device, a graphic data storage and mergers as the image processing system shown in FIG. 11. In this integrated image processing system, the controller 152 makes contact with the controller of the other image processing system 157 and performs transmission and reception of image data while ensuring synchronization.

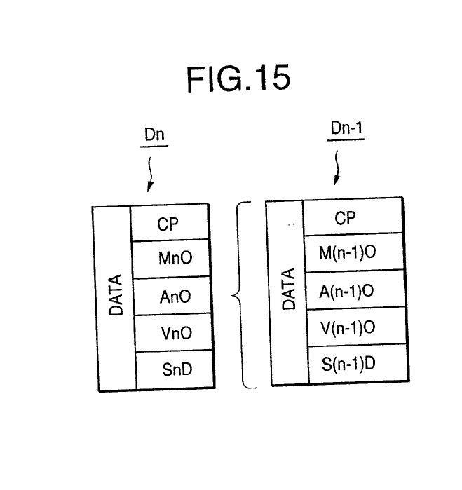

In such an integrated image processing system, it is preferable to use packet data shown in FIG. 15 as data to be transmitted to the image processing system 157. It is assumed that the image processing system determined by the controller 152 is an n-hierarchy system, while the image processing system 157 is an (n−1)-hierarchy system.

The image processing system 157 performs transmission and reception of data with the n-hierarchy image processing system via an image generator 155a which is one of the image generators 155. To the image generator 155a is sent data “An0” included in data Dn. As shown in FIG. 15, data “An0” includes data Dn−1. Data Dn−1 included in data “An0” is sent to the (n−1)-hierarchy image processing system 157 from the image generator 155a. In this manner, data is sent from the n-hierarchy image processing system to the (n−1)-hierarchy image processing system.

It may also be possible that an (n−2)-hierarchy image processing system is further connected to one of the image generators in the image processing system 157.

Using the data structure shown in FIG. 15, it is possible to send data from n-hierarchy configuration components to 0-hierarchy configuration components.

Moreover, it is possible to implement the integrated image processing system using an image processing system containable in one housing (e.g. image processing system 100 illustrated in FIG. 1) in place of one of the image generators 155 connected to the network in FIG. 14. In this case, it is necessary to provide a network interface for connecting the image processing system to the network used in the integrated image processing system.

In the foregoing embodiments, the image generators and mergers are all implemented in the semiconductor device. However, they can also be implemented in cooperation with a general-purpose computer and a program. Specifically, through reading and execution of a program recorded on a recording medium by a computer, it is possible to construct functions of the image generators and mergers in the computer. Moreover, part of the image generators and mergers may be implemented by semiconductor chips, and the other part may be implemented in cooperation with a computer and a program.

As described above, according to the present invention, a plurality of image data are specified in order of the depth distance included in each of image data. Moreover, color information of image data whose depth distance is relatively long and color information of image data for expressing an image in an overlapping manner over an image to be expressed by the foregoing image data whose depth distance is relatively long, are blended or merged to produce combined image data. This makes it possible to achieve an effect in which a 3-D image can be correctly expressed even if semitransparent images are complicatedly mixed in the 3-D image.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

1. An image processing system comprising:
a plurality of image generators each for generating image data including a depth distance, from a predetermined reference portion, of an image to be expressed by said image data, and color information of said image; and
a merger for receiving said image data from each of the plurality of image generators,
wherein said merger specifies the plurality of received image data in order of the depth distance included in each of said image data and merges the color information of the image data which is for expressing a first image whose depth distance is relatively long and the color information of the image data which is for expressing a second image in an overlapping manner over said first image.

2. The image processing system according to claim 1, wherein said depth distance is a depth distance of a pixel from the predetermined reference portion and said color information is color information of said pixel, and wherein said merger specifies the pixels in order of the depth distance of the pixel and merges the color information of the pixels.

3. The image processing system according to claim 2, wherein each of said image data includes depth distances of a plurality of pixels and color information of said pixels, and wherein said merger specifies the pixels having the same two-dimensional coordinates in order of the depth distance of the pixel and merges the color information of the pixels having the same two-dimensional coordinates.

4. The image processing system according to claim 1, wherein said merger merges the color information of the image data having the longest depth distance and the color information of the image data having the second longest depth distance, and further merges a result of the merging and the color information of the image data having the third longest depth distance.

5. The image processing system according to claim 4, wherein said merger merges the color information of the image data having the longest depth distance and color information of background image data for expressing a background.

6. The image processing system according to claim 4, wherein the image data having the longest depth distance is background image data for expressing a background.

7. The image processing system according to claim 1, wherein said color information includes luminance values representing three primary colors and a transparency value representing semitransparency.

8. The image processing system according to claim 1, further comprising a synchronizing unit for synchronizing timings of capturing the image data from the plurality of image generators with image processing timing of the image processing system.

9. The image processing system according to claim 8, wherein said plurality of image generators, said merger and said synchronizing unit are partly or wholly comprise a logic circuit and a semiconductor memory, and said logic circuit and said semiconductor memory are mounted on a semiconductor chip.

10. An image processing device comprising:
a data capturing unit for capturing image data from each of a plurality of image generators each of which generates the image data including a depth distance, from a predetermined reference portion, of an image to be expressed by said image data, and color information of said image; and
a color information merger for specifying the plurality of captured image data in order of the depth distance included in each of said image data and merging the color information of the image data which is for expressing a first image whose depth distance is relatively long and the color information of the image data which is for expressing a second image in an overlapping manner over said first image,
wherein said data capturing unit and said color information merger are mounted on a semiconductor chip.

11. The image processing device according to claim 10, further comprising a synchronizing unit for synchronizing timings of capturing the image data from the plurality of image generators with image processing timing of the image processing device.

12. An image processing device comprising:
a frame buffer for storing image data including color information of an image to be expressed by said image data;
a z-buffer for storing a depth distance of said image from a predetermined reference portion; and
a communication unit for communicating with a merger, said merger receiving said image data including said color information and said depth distance from each of a plurality of image processing devices including the subject image processing device to specify the plurality of received image data in order of the depth distance included in each of said image data and to merge the color information of the image data which is for expressing a first image whose depth distance is relatively long and the color information of the image data which is for expressing a second image in an overlapping manner over said first image,
wherein said frame buffer, said z-buffer and said communication unit are mounted on a semiconductor chip.

13. An image processing method to be executed in an image processing system including a plurality of image generators and a merger connected to the plurality of image generators, said method comprising the steps of:
causing said plurality of image generators to generate image data each including a depth distance, from a predetermined reference portion, of an image to be expressed by said image data, and color information of said image; and
causing said merger to capture said image data from each of said plurality of image generators at predetermined synchronizing timing, to specify the plurality of captured image data in order of the depth distance included in each of said image data and to merge the color information of the image data which is for expressing a first image whose depth distance is relatively long and the color information of the image data which is for expressing a second image in an overlapping manner over said first image.

14. A recording medium recorded with a computer program for causing a computer to be operated as an image processing system, the system comprising:
a plurality of image generators each for generating image data including a depth distance, from a predetermined reference portion, of an image to be expressed by said image data, and color information of said image; and
a merger for receiving said image data from each of the plurality of image generators,
wherein said merger specifies the plurality of received image data in order of the depth distance included in each of said image data and merges the color information of the image data which is for expressing a first image whose depth distance is relatively long and the color information of the image data which is for expressing a second image in an overlapping manner over said first image.

15. An image processing system comprising:
a data capturing unit for capturing, over a network, image data from each of a plurality of image generators each of which generates the image data including a depth distance, from a predetermined reference portion, of an image to be expressed by said image data, and color information of said image; and
a color information merger for specifying the plurality of captured image data in order of the depth distance included in each of said image data and merging the color information of the image data which is for expressing a first image whose depth distance is relatively long and the color information of the image data which is for expressing a second image in an overlapping manner over said first image.

16. An image processing system comprising:
a plurality of image generators each for generating image data including a depth distance, from a predetermined reference portion, of an image to be expressed by said image data, and color information of said image;
a plurality of mergers for capturing the image data generated by the plurality of image generators and merging the captured image data; and
a controller for selecting image generators and at least one merger necessary for processing from said plurality of image generators and said plurality of mergers,
wherein said plurality of image generators, said plurality of mergers and said controller are connected to one another over a network, and at least one of said plurality of mergers captures the image data from the selected image generators to specify the plurality of captured image data in order of the depth distance included in each of said image data and to merge the color information of the image data which is for expressing a first image whose depth distance is relatively long and the color information of the image data which is for expressing a second image in an overlapping manner over said first image.

17. The image processing system according to claim 16, wherein at least one of said selected image generators has other image generators connected thereto over a network different from said network, and image data is also generated by said other image generators.

18. The image processing system according to claim 16, wherein said image data includes data for specifying the target merger which captures said image data.

19. The image processing system according to claim 16, further comprising a switch for storing data for specifying the image generators and said at least one merger selected by said controller to capture the image data generated by the image generators specified by said stored data and to transmit said captured image data to said at least one merger specified by said stored data.
